(19) United States
(12) Patent Application Publication
(10) Pub. No.: US 2008/0236349 A1
(43) Pub. Date: Oct. 2, 2008

(54) Trim device for a lamination assembly

(75) Inventors: Brian C. Horsfield, Federal Way, WA (US); Douglas E. Redford, Edgewood, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/693,919

(22) Filed: Mar. 30, 2007

(51) Int. Cl. B26D 7/06

(52) U.S. Cl. 83/27; 83/104

(57) ABSTRACT

A trim device for a lamination apparatus is provided. The lamination apparatus provides a cellulous based panel with at least one polymeric layer. The trim device includes a housing and a material removal apparatus at least partially disposed within the housing. The trim device also includes a pressure source in communication with the material removal apparatus. The pressure source is adapted to provide a pressure differential to the cellulous based panel having a waste section. The pressure differential positions the waste section into communication with the material removal apparatus so that the waste section is removed from the cellulous based panel during operation of the trim device.

### BACKGROUND

Water resistant shipping containers are desirable for shipping many types of products, such as fresh produce and frozen goods. Currently available containers are typically manufactured from container blanks that are encapsulated within a water resistant film. Such blanks are assembled by applying a film to at least one side and, in some circumstances, both sides of the blank and trimming to size. The covered blank is then heated above the softening point of the film. The film becomes bonded to the surfaces of the blanks, and sags around the edges and into any openings so that the film on the two sides of the blank come into contact and are sealed together.

Thereafter, the edges and any slits and cutouts are trimmed, such as by a die cutter, while preserving the seals along the edges. One such method of manufacturing an encapsulated blank is disclosed in U.S. Pat. No. 6,338,234, entitled Method of Encapsulating Shipping Container Blanks in Plastic Film, assigned to Weyerhaeuser Company of Federal Way, Wash., the disclosure of which is hereby expressly incorporated by reference.

While current manufacturing methods are effective at encapsulating blanks, they are not without their problems. As a nonlimiting example, during the trimming process, the cutter may not trim away all unwanted material from cutting areas, such as handholds, tabs, etc. Also, if the encapsulation assembly is operating at a rate faster than its design speed, the cutter may not singulate all blanks. Thus, there exists a need for a trim device for a lamination apparatus.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A trim device for a lamination apparatus is provided. The lamination apparatus provides a cellulous based panel with at least one polymeric layer. The trim device includes a housing and a material removal apparatus at least partially disposed within the housing. The trim device also includes a pressure source in communication with the material removal apparatus. The pressure source is adapted to provide a pressure differential to the cellulous based panel having a waste section. The pressure differential positions the waste section into communication with the material removal apparatus so that the waste section is removed from the cellulous based panel during operation of the trim device.

A method of removing a waste section from a cellulous based panel is also provided. The method includes providing a cellulous based panel having at least one layer of lamination and a waste section, and displacing the waste section into a cutting position. The method further includes removing the waste section by impacting the waste section with a trim device after the waste section has been disposed into the cutting position.

### DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a side planar view of a trim device constructed in accordance with one embodiment of the present disclosure, showing the trim device incorporated in a schematic representation of a process for laminating cellulous based panels;

FIG. 2 is an isometric view of the trim device of FIG. 1 with a portion of the trim device removed to show a material removal apparatus;

FIG. 3 is an exploded view of the trim device of FIG. 2, showing components of the material removal apparatus partially exploded for clarity;

FIG. 4 is a side planar view of the trim device of FIG. 1; and

FIG. 5 is a side planar view of a trim device constructed in accordance with an another embodiment of the present disclosure, showing a blower in communication with the trim device to provide positive pressure.

### DETAILED DESCRIPTION

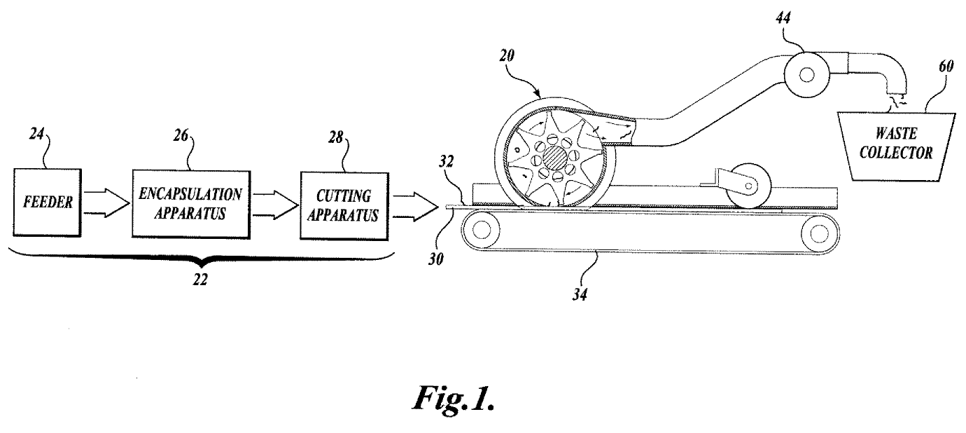

A trim device 20 constructed in accordance with one embodiment of the present disclosure maybe best understood by referring to FIGS. 1-4. The trim device 20 is illustrated for use in conjunction with a well-known lamination apparatus 22. The lamination apparatus 22 includes a feeder assembly 24, an encapsulation apparatus 26, and a cutting apparatus 28. The feeder assembly 24 provides a continuous supply of well-known blanks. One such feeder assembly 24 is disclosed in U.S. application Ser. No. 11/536,860, entitled Box Blank Feeder For Narrow Spacing, assigned to Weyerhaeuser Company of Federal Way, Wash., the disclosure of which is hereby expressly incorporated by reference.

The encapsulation apparatus 26 and cutting apparatus 28 are also well-known to provide at least one layer of lamination to the cellulose base blank. Such methods of laminating are disclosed in U.S. Pat. No. 6,338,234, entitled Method of Encapsulating Shipping Container Blanks in Plastic Film. The lamination apparatus 20 applies at least one water resistant layer to a container blank 30, suitably formed from well-known cellulose materials, such as wood pulp, straw, cotton, bagasse and the like. The water resistant layer is formed from well-known materials, such as a polymeric material, wax, and the like.

The cutting apparatus 28 is adapted to cut predetermined shapes, such as hand-holds, ventilation ports, and other defined apertures. Although cutting apparatuses 28 are effective at cutting such predetermined shapes from blanks 30, they sometimes fail to completely remove the material defining the aperture, thereby defining a waste section 32. Typically, the waste section 32 is attached to the blank 30 by a small portion of the waste section 32 still being attached to a portion of the blanks 30. To remove the waste section 32 from the blank 30, the blank 30 is fed to the trim device 20 on a well-known conveyor 34.

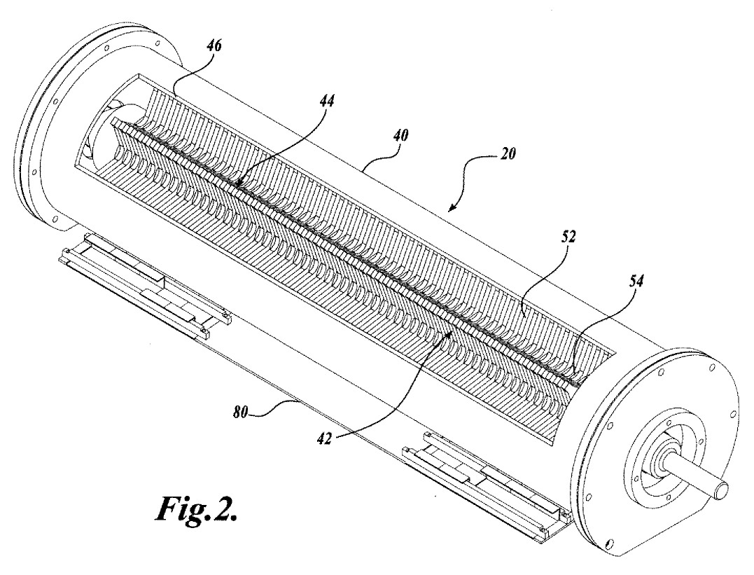

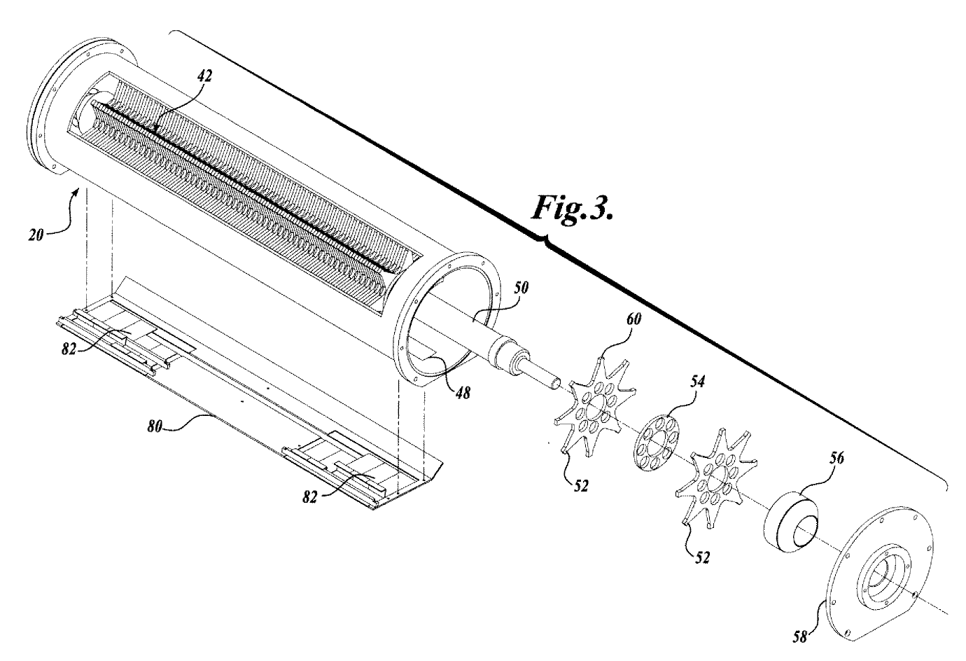

As may be best understood by referring to FIGS. 2 and 3, the trim device 20 includes a housing 40, a material removal apparatus 42, and a pressure source 44. The housing 40 is suitably a cylindrical member having a pressure source port 46 and a cutting port 48. The pressure source port 46 is suitably connected to the pressure source 44 in a well-known manner to create a pressure differential within the housing 40. The cutting port 48 is located at a surface of the housing 40 located adjacent a container blank 30, such that a portion of the material removal apparatus 42 comes into contact with the waste section 32, as described in greater detail below.

The trim device 20 may also include a slide gate damper assembly 80 connected to the housing 40 adjacent the cutting port 48, as shown best in FIGS. 2 and 3. The slide gate damper assembly 80 is adjustable relative to the opening defined by the cutting port 48 to accommodate blanks 30 of differing sizes. The slide gate damper assembly 80 includes a plurality of gates 82 that may be adjusted to vary the effective width and/or length of the cutting port 48 depending on the size of the blanks 30 passing through the trim device 20. This ensures that airflow through the housing 40 is maintained.

As may be best seen by referring to FIG. 3, the material removal apparatus 42 is at least partially disposed within the housing 40. The material removal apparatus 42, or cutting assembly, includes an axle 50 and a plurality of cutting blades 52. Alternating cutting blades 52 are spaced on the axle 50 by a plurality of spacers 54. The cutting blades 52 are suitably formed from a high strength material, such as steal and includes at least one cutting tip 60. As illustrated, the cutting blades 52 are configured as a star having multiple cutting tips 60 extending radially from the center of the cutting blade 52. It should be apparent that although a star-like configuration for the cutting blade 52 is illustrated and described, other configurations are within the scope of the present disclosure.

The cutting blades 52 and spacers 54 are rotatably disposed on the axle 50 and seated thereon by a well-known bearing 56. A drive motor (not shown) is suitably attached to one end of the axle 50 for driving the plurality of cutting blades 52. The material removal apparatus 42 is sealed within the housing 40 by an end cap 58. Although it is preferred that the material removal apparatus 42 be rotatably disposed within the housing 40, other configurations are within the scope of the present disclosure. As a non-limiting example, the cutting blades 52 may be disposed within the housing 40 and configured for translational movement laterally along the axle 50 in a side-to-side type of motion. Accordingly, such configurations are also within the scope of the appended claims.

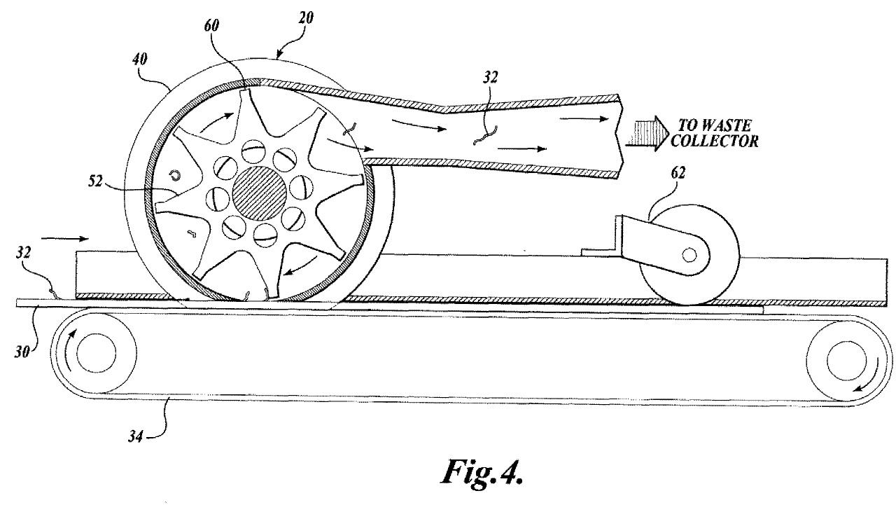

Operation of the trim device 20 may be best understood by referring to FIG. 4. A blank 30 is transported to the trim device 20 on the conveyer 34 such that the blank 30 passes beneath the cutting port 48 of the housing 40. As the blank 30 passes through the trim device 20, the pressure source 44, such as a vacuum supplying a negative pressure to the blank 30, causes the waste section 32 to be displaced into a cutting position relative to the material removal apparatus 42. Specifically, the pressure differential between the pressure source 44 and the atmospheric pressure causes the waste section 32 to be displaced at an angle relative to the planar surface of the blank 30. In this position, the waste section extends upwardly into the housing 40 through the cutting port 48.

In the cutting position, at least one cutting tip 60 of the cutting blade 52 engages the waste section 32, causing it to be separated from the blank 30. After the waste section 32 is separated from the blank 30, the pressure differential sucks the waste section 32 out of the housing 40 through the pressure source port 46 and into a waste collector 60. To assist in retaining the blank 30 on the conveyer 34 as it passes the trim device 20, a hold down roller 62 may be provided.

Although a pressure differential is preferred for displacing the waste section 32 into the cutting position, other methods are within the scope of the present disclosure. As an example, the material used to construct either the blank 30 or the lamination may be charged such that the waste section 32 may be displace it into the cutting position. As yet another example, the trim device 20 may include a scoop to lift the waste section 32 into the cutting position as the blank 30 passes the trim device 20.

In operation, the axle 50 may be rotated at a rate such that the cutting tip 60 has a tip speed of approximately 100 feet per second. The housing 40 is suitably under a negative pressure differential between 5 and 20 inches of water to induce an air flow into the housing 40. As noted above, this pressure differential causes the waste section 32 to lift upward from the surface of the blank 30 were it impacts with the cutting tip 60 and the waste section 32 raps around the cutting tip 60. This impact results in a momentum that causes the waste section 32 to be separated from the blank 30.

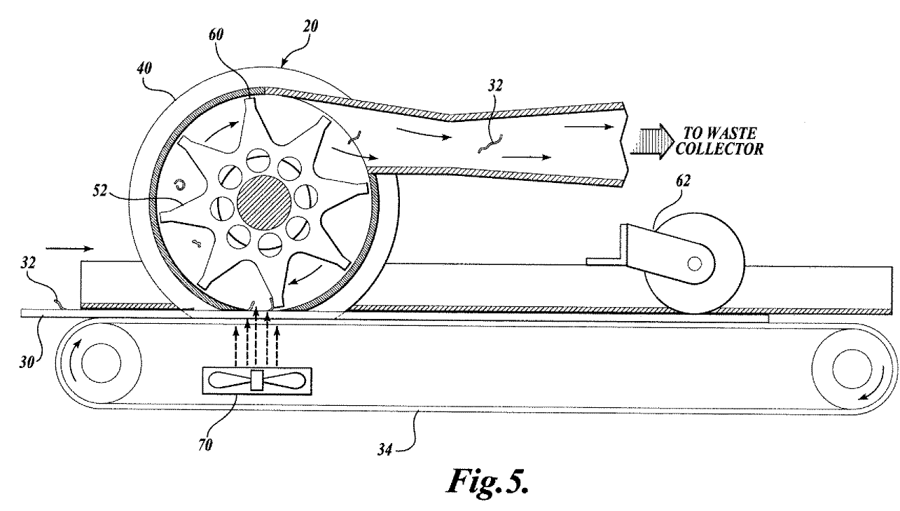

A trim device 110 constructed in accordance with an alternate embodiment of the present invention may be best understood by referring to FIG. 5. The trim device 120 is substantially identical in materials and operations to the primary embodiment described above with the following exceptions. Accordingly, like numbers refer to like elements in the proceeding embodiment. In the alternate embodiment of FIG. 5, includes a pressure source 70 that provides a positive pressure differential to the housing 40 of the trim device 120. Such a pressure source 70 includes fans and other well-known blowers. Operationally, the pressure source 70 blows air upwardly through the blank 30 to displace the waste section 32 into the cutting position were it is removed from the blank 30 by the material removal apparatus 42, in a manner described above.

While illustrative embodiments have been illustrated and described, it will be appreciated that various changes can be made therein without departing from the spirit and scope of the invention. As an example, the conveyor 34 may include an embedded vacuum source to assist in retaining the blank 30 as it is transported to the trim device 20. As a result, such embodiments are also contemplated with the scope of the appended claims.

The embodiments of the invention in which an exclusive property or privilege is claimed are defined as follows:

1. A trim device for a lamination apparatus, the lamination apparatus providing a cellulous based panel with at least one water resistant layer, the trim device comprising:
(a) a housing;
(b) a material removal apparatus at least partially disposed within the housing; and
(c) a pressure source in communication with the material removal apparatus and adapted to provide a pressure differential to the cellulous based panel having a waste section, the pressure differential positioning the waste section into communication with the material removal apparatus so that the waste section is removed from the cellulous based panel during operation of the trim device.

2. The trim device of claim 1, wherein the pressure source is a vacuum.

3. The trim device of claim 1, wherein the pressure source is a blower.

4. The trim device of claim 1, wherein the pressure source extracts the waste section from the housing after the waste section is removed from the cellulous based panel.

5. The trim device of claim 1, wherein the material removal apparatus includes a plurality of cutting blades disposed within the housing for removing the waste section during operation of the trim device.

6. The trim device of claim 5, wherein the plurality of cutting blades are rotatably disposed within the housing.

7. The trim device of claim 6, further comprising a damper assembly coupled to the housing.

8. A trim device for a lamination apparatus, the lamination apparatus providing a cellulous based panel with at least one polymeric layer, the trim device comprising:
(a) a housing;
(b) a cutting assembly located within the housing and positioned within the housing for selective engagement with a waste section of the cellulous based panel selectively located in proximity to the housing; and
(c) a pressure source in communication with the housing, the pressure source providing a pressure differential to the cellulous based panel located in proximity to the housing, wherein the pressure differential displacing the waste section into a cutting position relative to the cutting assembly.

9. The trim device of claim 8, wherein the pressure differential is a positive pressure.

10. The trim device of claim 8, wherein the pressure differential is a negative pressure.

11. The trim device of claim 8, wherein the cutting assembly includes a plurality of cutting blades.

12. The trim device of claim 11, wherein the pressure source removes the waste section from the housing after the waste section has been removed from the cellulous based panel.

13. The trim device of claim 12, further comprising a damper assembly coupled to the housing.

14. A method of removing a waste section from a cellulous based panel, comprising:
(a) providing a cellulous based panel having at least one layer of lamination and a waste section;
(b) displacing the waste section into a cutting position; and
(c) removing the waste section by impacting the waste section with a trim device after the waste section has been disposed into the cutting position.

15. The method of removing a waste section from a cellulous based panel of claim 14, wherein displacing the waste section into a cutting position includes applying a pressure differential to the cellulous based panel.

16. The method of removing a waste section from a cellulous based panel of claim 15, wherein the pressure differential is a negative pressure.

17. The method of removing a waste section from a cellulous based panel of claim 16, wherein the trim device includes a cutting assembly disposed within a housing.

18. The method of removing a waste section from a cellulous based panel of claim 17, wherein the cutting assembly includes a plurality of cutting blades.

19. The method of removing a waste section from a cellulous based panel of claim 18, wherein the pressure differential removes the waste section from within the housing after the waste section has been removed from the cellulous based panel.

20. The method of removing a waste section from a cellulous based panel of claim 15, wherein the pressure differential is a positive pressure.
